(19) United States
(12) Patent Application Publication
(10) Pub. No.: US 2023/0066663 A1
(43) Pub. Date: Mar. 2, 2023

(54) DETERMINING RECORD IMPORTANCE

(71) Applicant: International Business Machines Corporation, Armonk, NY (US)

(72) Inventors: Si Er Han, Xi'an (CN); Xiao Ming Ma, Xi'an (CN); Jing Xu, Xi'an (CN); Xue Ying Zhang, Xi'an (US); Ji Hui Yang, Beijing (CN)

(21) Appl. No.: 17/465,018

(22) Filed: Sep. 2, 2021

(51) Int. Cl. G06N 5/02; G06F 16/906

(52) U.S. Cl. CPC G06N 5/022; G06F 16/906

(57) ABSTRACT

Embodiments herein describe computer-implemented methods, computer program products, and computer systems for determining record importance. The methods may include providing a first trained model having a first trained model accuracy. Further, the methods may include clustering the training data to generate clustered data groups, extracting a first clustered data group from the clustered data groups to identify first model test data, processing the first model test data using the first trained model to generate first trained model output data having first test data accuracy, and labeling the first clustered data group with a first record importance level based on a first comparison between the first trained model accuracy and the first test data accuracy. Further, the methods may include clustering the training data by processing the training data using hierarchical clustering to group the training data into the clustered data groups based on features corresponding to a hierarchy of importance.

### BACKGROUND

The present invention relates generally to the field of predictive modeling, and more particularly to evaluating data record groups and determining record importance using model features.

Model explanation machine learning becomes quite important because model explanation machine learning can help users to understand a predictive model and derive useful insights from data. Feature and/or predictor importance is one of the typical techniques for model explanation machine learning. Feature and/or predictor importance assigns an importance measure to each feature by comparing the quality of a model with and without a feature. From the importance, it is easy for a user to understand how much the feature affects the predictive model.

In feature importance, features are evaluated independently. However, in practice, model quality is often affected by several features together, and the affection may be different from record to record. Some records may have a clear pattern that can help to improve the model accuracy, while other records may be disturbed by noise and have negative impacts on the model. Therefore, it is necessary to explore the importance of records when a prediction model is built. With the records’ importance, one can determine if some records should be included in the model or not.

### SUMMARY

Embodiments of the present invention describe a computer-implemented method, a computer program product, and a computer system to calculate importance of records.

In an embodiment, the computer-implemented method may include one or more processors configured for providing a first trained model having a first trained model accuracy, the first trained model trained using training data; clustering the training data to generate clustered data groups; extracting a first clustered data group from the clustered data groups to produce or identify first model test data; processing the first model test data using the first trained model to generate first trained model output data having first test data accuracy; and labeling the first clustered data group with a first record importance level based on a first comparison between the first trained model accuracy and the first test data accuracy.

### BRIEF DESCRIPTION OF THE DRAWINGS

FIG. 1 is a functional block diagram illustrating a distributed data processing environment for determining record importance, in accordance with an embodiment of the present invention;

FIG. 2 is a block workflow diagram illustrating a process for determining record importance, in accordance with an embodiment of the present invention;

FIG. 3 illustrates a clustered data group model for determining record importance, in accordance with an embodiment of the present invention;

FIG. 4 illustrates an importance data group difference model, for determining record importance, in accordance with an embodiment of the present invention;

FIG. 5 illustrates a balanced data group model for determining record importance, in accordance with an embodiment of the present invention;

FIG. 6 is a flowchart of an approach for determining record importance, in accordance with an embodiment of the present invention; and

FIG. 7 depicts a block diagram of components of a computing device executing the approach for determining record importance within the distributed data processing environment of FIG. 1, in accordance with an embodiment of the present invention.

### DETAILED DESCRIPTION

Embodiments of the present invention recognize that there are large numbers of records during model building, and it is extremely difficult to evaluate each individual record and assign an importance value to each individual record. Therefore, solution is needed evaluate the data record group in a hierarchical tree, so that a decision can be made to keep or remove proper data groups.

Embodiments of the present invention describe computer-implemented methods, computer program products and systems for determining record importance by performing hierarchical clustering to structured data to determine and identify interesting data groups. Model evaluation is quite useful to understand a predictive model and derive useful insights from data. Predictor importance is one of the typical evaluation measures to perform model evaluation to understand a predictive model and derive useful insights from data. Similar to predictor importance, case importance, which assists in determining which cases are importance for modeling and which cases are negative, is useful when included in training cases. Case importance may be defined for data groups as opposed to individual cases because there should be a sufficient number of cases to achieve reliable patterns.

In determining which records in a hierarchal data group to keep, a computer-implemented method may be executed to identify and profile interesting data groups in each hierarchical level, which may have a positive or a negative impact on predictive modeling. For example, the method may identify interesting data groups in each hierarchical level for applications such as down-sampling, so that proper data groups may be retained or removed.

Embodiments described herein may include one or more processors configured to apply hierarchical clustering, so that for each level of clustering, all training data may be condensed into various data groups based on certain features present in the training data.

Further, for each level or hierarchical clustering, the one or more processors may be configured to apply a leave-one-out method to remove one data group each time. After a data group is removed, a predictive model may be built on the remaining data groups and evaluate the model on the testing data.

Further, in an embodiment, the computer-implemented method may be configured to determine the accuracy of the model when a data group is removed, then compare the accuracy with the overall accuracy. For example, a model may be built on all data and an overall accuracy of the model may be determined through a calculation of the expected results versus the test results.

In an embodiment, the data group importance may be computed as the difference between the overall accuracy of the model built on the original data set and the accuracy of the model without the removed data group. For example, the one or more processors may be configured to cluster the data and label each record to get a k-cluster. For each cluster, the one or more processors may be configured to extract the cluster records from the data set and use the remaining data to update the model and then evaluate the model accuracy corresponding to a k accuracy. Once the k accuracy is determined, the k accuracy may be compared to the overall accuracy, wherein the overall accuracy corresponds to the accuracy without the cluster.

Further, the one or more processors may be configured to use hierarchy cluster to label records to support records importance hierarchy analysis. In an embodiment, the computer-implemented method may be configured to display the data group’s importance value and interestingness information on the hierarchical cluster data view.

Implementation of embodiments of the invention may take a variety of forms, and exemplary implementation details are discussed subsequently with reference to the Figures.

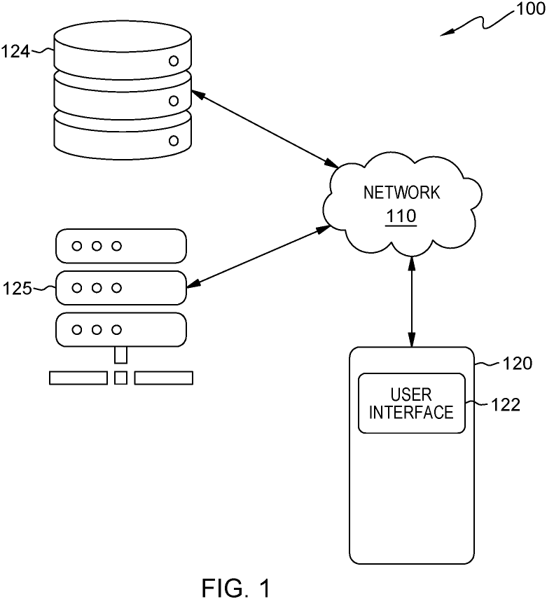

FIG. 1 is a functional block diagram illustrating a distributed data processing environment for determining record importance, generally designated 100, in accordance with an embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, distributed data processing environment 100 includes computing device 120, server 125, and database 124, interconnected over network 110. Network 110 operates as a computing network that can be, for example, a local area network (LAN), a wide area network (WAN), or a combination of the two, and can include wired, wireless, or fiber optic connections. In general, network 110 can be any combination of connections and protocols that will support communications between computing device 120, server 125, and database 124. Distributed data processing environment 100 may also include additional servers, computers, or other devices not shown.

Computing device 120 operates to execute at least a part of a computer program for determining record importance. In an embodiment, computing device 120 may be configured to send and/or receive data from one or more of the other computing device(s) via network 110. Computing device 120 may include user interface 122 configured to facilitate interaction between a user and computing device 120. For example, user interface 122 may include a display as a mechanism to display data to a user and may be, for example, a touch screen, light emitting diode (LED) screen, or a liquid crystal display (LCD) screen. User interface 122 may also include a keypad or text entry device configured to receive alphanumeric entries from a user. User interface 122 may also include other peripheral components to further facilitate user interaction or data entry by user associated with computing device 120.

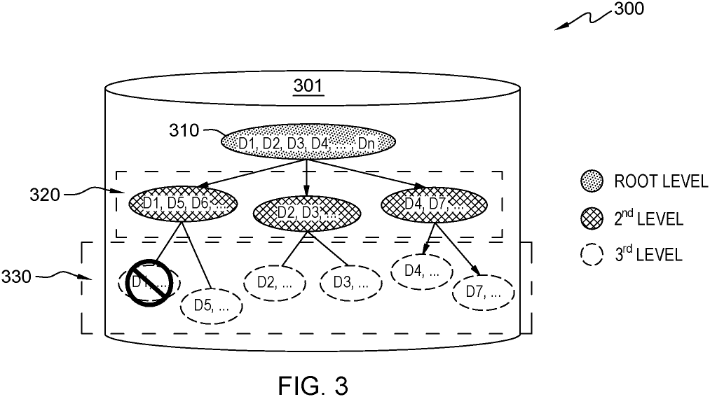

In some embodiments, computing device 120 may be a management server, a web server, or any other electronic device or computing system capable of receiving and sending data. In some embodiments, computing device 120 may be a laptop computer, tablet computer, netbook computer, personal computer (PC), a desktop computer, a smart phone, or any programmable electronic device capable of communicating with database 124, server 125 via network 110. Computing device 120 may include components as described in further detail in FIG. 3.

Computing device 120 may be configured to receive, store, and/or process data received via communication with other computing device(s) connected to network 110. For example, computing device 120 may be communicatively coupled to database 124 and/or server 125 and receive, via a communications link, data corresponding to determining record importance and associated third-party APIs. Computing device 120 may be configured to store the data in memory or transmit the data to database 124 and/or server 125 via network 110 for further storage and/or processing.

Database 124 operates as a repository for data flowing to and from network 110. Examples of data include training data, clustered groups of data, model test data, model output data, trained model output data, and other data that may be determined based on the previously mentioned data. A database is an organized collection of data. Database 124 can be implemented with any type of storage device capable of storing data and configuration files that can be accessed and utilized by computing device 120 and/or a database server, a hard disk drive, or a flash memory. In an embodiment, database 124 is accessed by computing device 120 to store data corresponding to determining record importance. In another embodiment, database 124 may reside elsewhere within distributed network environment 100 provided database 124 has access to network 110.

Server 125 can be a standalone computing device, a management server, a web server, or any other electronic device or computing system capable of receiving, sending, and processing data and capable of communicating with computing device 120 and/or database 124 via network 110. In other embodiments, server 125 represents a server computing system utilizing multiple computers as a server system, such as a cloud computing environment. In yet other embodiments, server 125 represents a computing system utilizing clustered computers and components (e.g., database server computers, application server computers, etc.) that act as a single pool of seamless resources when accessed within distributed data processing environment 100. Server 125 may include components as described in further detail in FIG. 3.

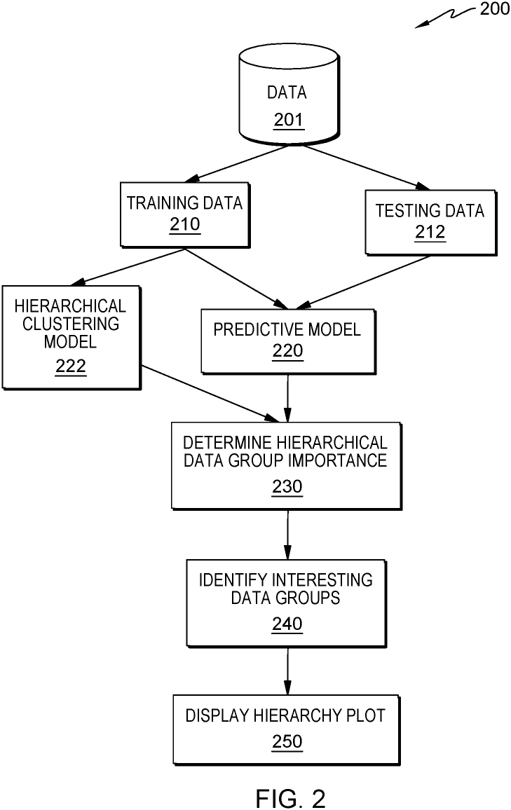

FIG. 2 is a block workflow diagram illustrating a process 200 for determining record importance, in accordance with an embodiment of the present invention.

In some aspects of an embodiment of the present invention, process 200 may include one or more processors configured for determining training data 210 and testing data 212 based on one or more parameters corresponding to data 201. For example, determining training data 210 and testing data 212 may include one or more processors dividing data 201 into training data 210 and testing data 212 based on the one or more parameters. Further, data 201 may include 10,000 records, wherein training data 210 may include 3,000 records of the 10,000 records and testing data 212 may include 7,000 records of the 10,000 records. In another example, data 201 may include 10,000 records of which testing data 212 may include 3,000 records and training data 210 may include 7,000 records.

In some aspects of an embodiment of the present invention, process 200 may include one or more processors configured for building hierarchical clustering model 222 based at least on training data 210. For example, process 200 may include one or more processors configured for transmitting training data 210 to hierarchical clustering model 222, processing training data 210 by hierarchical clustering model 222, and generating clustering model output data for further evaluation. Processing training data 210 may include clustering training data 210 into various groups based on some feature or characteristic that is common among the various groups, similar to unsupervised learning techniques (e.g., hierarchical clustering, K-means).

In some aspects of an embodiment of the present invention, process 200 may include one or more processors configured for building predictive model 220 based at least on training data 210 and/or testing data 212. For example, process 200 may include one or more processors configured for transmitting training data 210 and/or testing data 212 to predictive model 220, processing training data 210 and/or testing data 212 by predictive model 220, and generating predictive model output data for further evaluation. In an embodiment, the same training data 210 and/or the same testing data 212 may be used to build predictive model 220 to determine overall accuracy of the model.

In some aspects of an embodiment of the present invention, process 200 may include one or more processors configured for determining 230 hierarchical data group importance. For example, process 200 may include one or more processors configured for processing one or more of clustering model output data and predictive model output data to evaluate the importance of the hierarchical data group. In an embodiment, testing data 212 may be used in performing the importance evaluation of the data groups for each hierarchical level. Data groups may be determined based on one or more parameters or features (e.g., prediction accuracy) of the data groups. For example, a first data group may be evaluated to be more important than a second data group if the first data group, once processed by predictive model 220, has a higher prediction accuracy than the second data group.

In some aspects of an embodiment of the present invention, process 200 may include one or more processors configured for identifying 240 interesting data groups based on a result of the importance evaluation. For example, a data group may be identified as interesting if one or more features of the data group is distinctive from features of another data group. For instance, if a first data group has a prediction accuracy that is greater than the prediction accuracy of a second data group that is greater than a predetermined threshold, then the first data group may be identified as interesting and the second data group may be identified as not interesting, or vice versa. Other data group features or parameters may be used to identify interesting data groups so long as some measure of distinction can be ascertained between the data groups.

In some aspects of an embodiment of the present invention, process 200 may include one or more processors configured to display 250 a hierarchy plot of the data groups according to their respective features and distinctiveness.

FIG. 3 illustrates a clustered data group model 300 for determining record importance, in accordance with an embodiment of the present invention.

In some aspects of an embodiment of the present invention, clustered data group model 300 may include database 301 comprising data 201 (e.g., D1, D2, D3, ..., Dn) at a root level 310 in database 301, wherein one or more processors may be configured to perform hierarchical clustering on data 201 to generate clustered data groups (e.g., first group: D1, D5, D6, ..., Dn; second group: D2, D3, ..., Dn; third group: D4, D7, ..., Dn) at a second level 320 in database 301. Further, the one or more processors may be configured to evaluate a first model by processing testing data 212, and for each hierarchical level, evaluate the importance for each data group in testing data 212 by various methods. For example, the one or more processors may be configured to remove a data group (e.g., D1) and build a new model with the remaining training data and evaluate the new model.

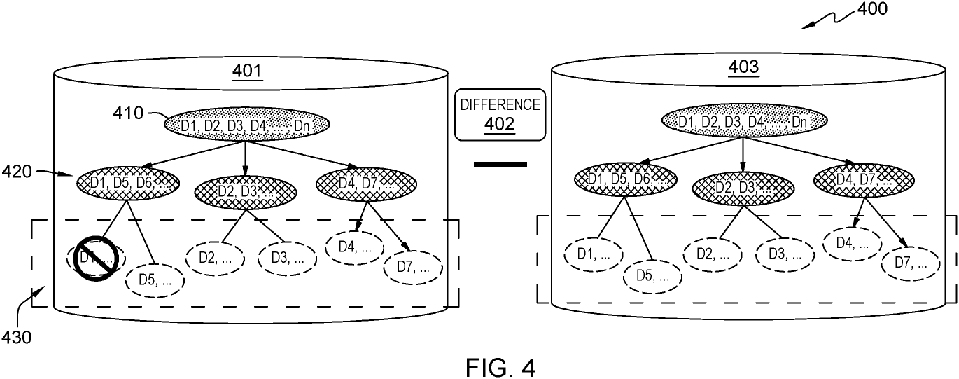

FIG. 4 illustrates importance data group difference models 400, for determining record importance, in accordance with an embodiment of the present invention.

In some aspects of an embodiment of the present invention, importance data group models 400 may include one or more processors configured for evaluating the difference 402 of qualities between first model 401 and second model 403, wherein a data group (e.g., D1) was removed from first model 401. For example, if the prediction accuracy of first model 401 is greater than the prediction accuracy of second model 403, then the one or more processors may be configured to determine that the removed data group (e.g., D1) is less important than one or more of the remaining data groups (e.g., D5, D2, D3, D4, D7, ..., Dn) or the remaining data groups (e.g., D5, D2, D3, D4, D7, ..., Dn) are more important than the removed data group (e.g., D1). Such determination of data group importance may be based upon prediction accuracy of the models (e.g., first model 401, second model 403) under evaluation.

In an embodiment, determining data group importance may include one or more processors configured for ranking data groups according to the measure of importance for each hierarchical level. For example, the importance measure could be negative for data groups that are harmful to the prediction accuracy of the model. In other words, data groups with negative importance measures may be harmful data groups. Further, data groups with a significantly high importance (e.g., importance greater than mean+2*std.) may be the beneficial data groups. For instance, if a data group is removed from a model, and the model accuracy decreases upon an importance evaluation, then that data group may be identified as a beneficial data group.

Further, if a data group is removed from a model, and the model accuracy increases upon an importance evaluation, then that data group may be identified as a harmful data group. Each data group may be removed from the model to perform an importance evaluation on that data group to determine the quality of that data group. Data group removal may be performed iteratively until all data groups are are evaluated with respect to the model, with the harmful data groups being removed from further consideration. Subsequently identified data groups may be classified as harmful or beneficial once one or more harmful data groups are removed to further improve model accuracy.

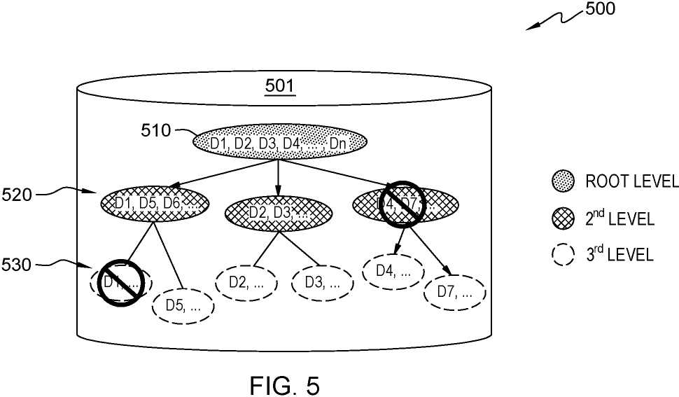

FIG. 5 illustrates a balanced data group model 500 for determining record importance, in accordance with an embodiment of the present invention.

In some aspects of an embodiment of the present invention, balanced data group model 500 may include one or more processors configured for down-sampling for imbalanced data. For example, the one or more processors may be configured for comparing model 500 with random removal of data to remove data from each branch (e.g., root level 510, second level 520, third level 530) to maintain distribution balance. Further, the one or more processors may be configured for removing data that decrease, maintain, or increase model accuracy based on model parameters specified by a client or user designing or using model 500.

In an embodiment, model 500 may be configured to identify interesting data groups in each hierarchical level or each branch, provide guidance (e.g., identifying important data groups) for a user or client to remove data from each branch to keep distribution balance and facilitate or enable the user or client to remove data that either decrease, maintain, or increase model accuracy based on program or model parameters.

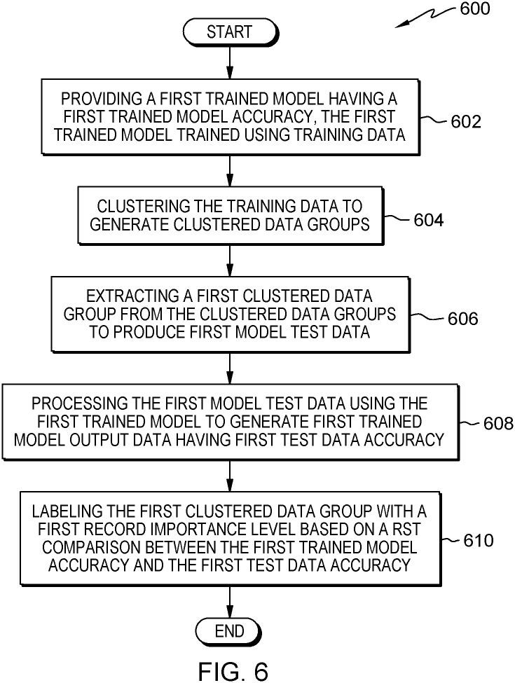

FIG. 6 is a flowchart of a computer-implemented method 600 executed within distributed data processing environment 100 for determining record importance, in accordance with an embodiment of the present invention.

In an embodiment, computer-implemented method 600 may include one or more processors configured for providing 602 a first trained model having a first trained model accuracy, the first trained model trained using training data. In an embodiment, training the first trained model may include one or more processors configured for receiving training data at a first model and processing the training data by the first model to provide the first trained model. Processing the training data may include unsupervised learning techniques performed on the training data to generate model trained model output data corresponding to groups of data that may be characterized by one or more features of the data groups.

In an embodiment, computer-implemented method 600 may include one or more processors configured for clustering 604 the training data to generate clustered data groups. In an embodiment, clustering 604 the training data may further include one or more processors configured for processing the training data using hierarchical clustering to group the training data into the clustered data groups based on one or more features corresponding to a hierarchy of importance.

In an embodiment, clustering 604 the training data may further include one or more processors configured for determining the first record importance level as a difference between the first trained model accuracy and the first test data accuracy. For example, in response to the first test data accuracy being greater than the first trained model accuracy, the first record importance level of the first clustered data group is less important than one or more of remaining clustered data groups.

In an embodiment, computer-implemented method 600 may include one or more processors configured for extracting 606 a first clustered data group from the clustered data groups to produce or identify first model test data. In an embodiment, extracting 606 the first clustered data group may further include applying a leave-one-out method to the clustered data groups to remove one of the clustered data groups at a time, wherein the first model test data includes a remaining set of the clustered data groups excluding the first clustered data group. For example, the leave-one-out method is a special case of cross validation, as known to those of ordinary skill in the art, where the number of folds equals the number of instances in the data set. Thus, the learning algorithm is applied once for each instance, using all other instances as a training set, and using the selected instance as a single-item test set.

In an embodiment, computer-implemented method 600 may include one or more processors configured for processing 608 the first model test data using the first trained model to generate first trained model output data having first test data accuracy.

In an embodiment, computer-implemented method 600 may include one or more processors configured for labeling 610 the first clustered data group with a first record importance level based on a first comparison between the first trained model accuracy and the first test data accuracy.

In an embodiment, computer-implemented method 600 for determining record importance may further include one or more processors configured for extracting a second clustered data group from the clustered data groups to produce or identify second model test data and processing the second model test data using the first trained model to generate second trained model output data having second test data accuracy.

In an embodiment, computer-implemented method 600 for determining record importance may further include labeling the second clustered data group with a second record importance level based on a second comparison between the first trained model accuracy and the second test data accuracy; and generating a hierarchical cluster data view illustrating record importance levels of the clustered data groups on a user interface of a computing device.

In an embodiment, the second record importance level of the second clustered data group may be less than the first record importance level of the first clustered data group if the second test data accuracy is greater than the first trained model accuracy and less than the first test data accuracy.

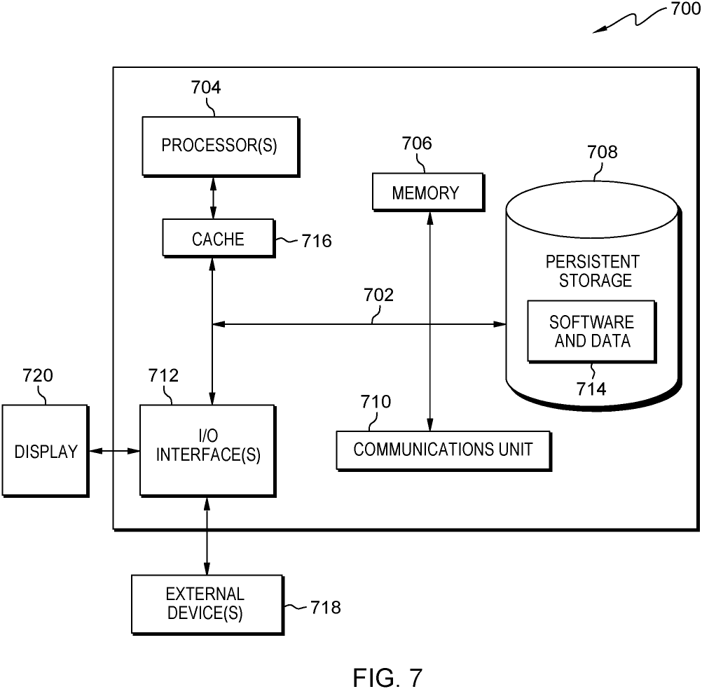

FIG. 7 depicts a block diagram of components of computing device 700 executing the computer-implemented method 600 for updating data templates within the distributed data processing environment 100 of FIG. 1, in accordance with an embodiment of the present invention. FIG. 7 depicts a block diagram of computing device 700 suitable for server 125 or computing device 120, in accordance with an illustrative embodiment of the present invention. It should be appreciated that FIG. 7 provides only an illustration of one implementation and does not imply any limitations with regard to the environments in which different embodiments can be implemented. Many modifications to the depicted environment can be made.

Computing device 700 includes communications fabric 702, which provides communications between cache 716, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses or a crossbar switch.

Memory 706 and persistent storage 708 are computer readable storage media. In this embodiment, memory 706 includes random access memory (RAM). In general, memory 706 can include any suitable volatile or non-volatile computer readable storage media. Cache 716 is a fast memory that enhances the performance of computer processor(s) 704 by holding recently accessed data, and data near accessed data, from memory 706.

Programs may be stored in persistent storage 708 and in memory 706 for execution and/or access by one or more of the respective computer processors 704 via cache 716. In an embodiment, persistent storage 708 includes a magnetic hard disk drive. Alternatively, or in addition to a magnetic hard disk drive, persistent storage 708 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 710, in these examples, provides for communications with other data processing systems or devices. In these examples, communications unit 710 includes one or more network interface cards. Communications unit 710 may provide communications through the use of either or both physical and wireless communications links. Programs, as described herein, may be downloaded to persistent storage 708 through communications unit 710.

I/O interface(s) 712 allows for input and output of data with other devices that may be connected to server 125 and/or computing device 120. For example, I/O interface 712 may provide a connection to external devices 718 such as a keyboard, a keypad, a touch screen, and/or some other suitable input device. External devices 718 can also include portable computer readable storage media such as, for example, thumb drives, portable optical or magnetic disks, and memory cards. Software and data 714 used to practice embodiments of the present invention can be stored on such portable computer readable storage media and can be loaded onto persistent storage 708 via I/O interface(s) 712. I/O interface(s) 712 also connect to a display 720.

Display 720 provides a mechanism to display data to a user and may be, for example, a computer monitor.

Software and data 714 described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a computer-implemented method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a component, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for determining record importance, the computer-implemented method comprising:
providing, by one or more processors, a first trained model having a first trained model accuracy, the first trained model trained using training data;
clustering, by the one or more processors, the training data to generate clustered data groups;
extracting, by the one or more processors, a first clustered data group from the clustered data groups to identify first model test data;
processing, by the one or more processors, the first model test data using the first trained model to generate first trained model output data having first test data accuracy; and
labeling, by the one or more processors, the first clustered data group with a first record importance level based on a first comparison between the first trained model accuracy and the first test data accuracy.

2. The computer-implemented method of claim 1, wherein clustering the training data further comprises:
processing, by the one or more processors, the training data using hierarchical clustering to group the training data into the clustered data groups based on one or more features corresponding to a hierarchy of importance.

3. The computer-implemented method of claim 1, wherein extracting the first clustered data group further comprises:
applying, by the one or more processors, a leave-one-out method to the clustered data groups to remove one of the clustered data groups at a time, wherein the first model test data includes a remaining set of the clustered data groups excluding the first clustered data group.

4. The computer-implemented method of claim 1, further comprising:
determining, by the one or more processors, the first record importance level as a difference between the first trained model accuracy and the first test data accuracy.

5. The computer-implemented method of claim 1, wherein in response to the first test data accuracy being greater than the first trained model accuracy, the first record importance level of the first clustered data group is less important than one or more of remaining clustered data groups.

6. The computer-implemented method of claim 1, further comprising:
extracting, by the one or more processors, a second clustered data group from the clustered data groups to identify second model test data; and
processing, by the one or more processors, the second model test data using the first trained model to generate second trained model output data having second test data accuracy.

7. The computer-implemented method of claim 6, further comprising:
labeling, by the one or more processors, the second clustered data group with a second record importance level based on a second comparison between the first trained model accuracy and the second test data accuracy; and
generating, by the one or more processors, a hierarchical cluster data view illustrating record importance levels of the clustered data groups on a user interface of a computing device.

8. A computer program product for determining record importance, the computer program product comprising:
one or more computer readable storage media and program instructions collectively stored on the one or more computer readable storage media, the program instructions comprising:
program instructions to provide a first trained model having a first trained model accuracy, the first trained model trained using training data;
program instructions to cluster the training data to generate clustered data groups;
program instructions to extract a first clustered data group from the clustered data groups to identify first model test data;
program instructions to process the first model test data using the first trained model to generate first trained model output data having first test data accuracy; and
program instructions to label the first clustered data group with a first record importance level based on a first comparison between the first trained model accuracy and the first test data accuracy.

9. The computer program product of claim 8, wherein the program instructions to cluster the training data further comprises:
program instructions to process the training data using hierarchical clustering to group the training data into the clustered data groups based on one or more features corresponding to a hierarchy of importance.

10. The computer program product of claim 8, wherein the program instructions to extract the first clustered data group further comprises:
program instructions to apply a leave-one-out method to the clustered data groups to remove one of the clustered data groups at a time, wherein the first model test data includes a remaining set of the clustered data groups excluding the first clustered data group.

11. The computer program product of claim 8, further comprising:
program instructions to determine the first record importance level as a difference between the first trained model accuracy and the first test data accuracy.

12. The computer program product of claim 8, wherein in response to the first test data accuracy being greater than the first trained model accuracy the first record importance level of the first clustered data group is less important than one or more of remaining clustered data groups.

13. The computer program product of claim 8, further comprising:
program instructions to extract a second clustered data group from the clustered data groups to identify second model test data; and
program instructions to process the second model test data using the first trained model to generate second trained model output data having second test data accuracy.

14. The computer program product of claim 13, further comprising:
program instructions to label the second clustered data group with a second record importance level based on a second comparison between the first trained model accuracy and the second test data accuracy; and
program instructions to generate a hierarchical cluster data view illustrating record importance levels of the clustered data groups on a user interface of a computing device.

15. A computer system for determining record importance, the computer system comprising:
one or more computer processors;
one or more computer readable storage media;
program instructions collectively stored on the one or more computer readable storage media for execution by at least one of the one or more computer processors, the program instructions comprising:
program instructions to provide a first trained model having a first trained model accuracy, the first trained model trained using training data;
program instructions to cluster the training data to generate clustered data groups;
program instructions to extract a first clustered data group from the clustered data groups to identify first model test data;
program instructions to process the first model test data using the first trained model to generate first trained model output data having first test data accuracy; and
program instructions to label the first clustered data group with a first record importance level based on a first comparison between the first trained model accuracy and the first test data accuracy.

16. The computer system of claim 15, wherein the program instructions to cluster the training data further comprises:
program instructions to process the training data using hierarchical clustering to group the training data into the clustered data groups based on one or more features corresponding to a hierarchy of importance.

17. The computer system of claim 15, wherein the program instructions to extract the first clustered data group further comprises:
program instructions to apply a leave-one-out method to the clustered data groups to remove one of the clustered data groups at a time, wherein the first model test data includes a remaining set of the clustered data groups excluding the first clustered data group.

18. The computer system of claim 15, further comprising:
program instructions to determine the first record importance level as a difference between the first trained model accuracy and the first test data accuracy, wherein in response to the first test data accuracy being greater than the first trained model accuracy, the first record importance level of the first clustered data group is less important than one or more of remaining clustered data groups.

19. The computer system of claim 15, further comprising:
program instructions to extract a second clustered data group from the clustered data groups to identify second model test data; and
program instructions to process the second model test data using the first trained model to generate second trained model output data having second test data accuracy.

20. The computer system of claim 19, further comprising:
program instructions to label the second clustered data group with a second record importance level based on a second comparison between the first trained model accuracy and the second test data accuracy; and
program instructions to generate a hierarchical cluster data view illustrating record importance levels of the clustered data groups on a user interface of a computing device.
